(19) United States
(12) Patent Application Publication
(10) Pub. No.: US 2025/0109237 A1
(43) Pub. Date: Apr. 3, 2025

(54) HIGH BIO RENEWABLE CONTENT INKS FOR LAMINATING PRINTING INKS

(71) Applicant: Sun Chemical Corporation, Parsippany (NJ)

(72) Inventors: Xiaobo ZHU; Ralph ARCURIO, Carlstadt, NJ (US); Evan MARGARETTA, Matawan, NJ (US); Stewart CARSON, Rochdale, Lancashire (GB); Robert DEIGHTON, Rochdale, Lancashire (GB)

(73) Assignee: Sun Chemical Corporation, Parsippany (NJ)

(21) Appl. No.: 18/864,128

(22) PCT Filed: Jul. 18, 2023
(86) PCT No.: PCT/US2023/028024

§ 371 Date: Nov. 8, 2024

Related U.S. Application Data
(60) Provisional application No. 63/391,047, filed on Jul. 21, 2022.

(51) Int. Cl. C08G 18/32; C08G 18/08; C08G 18/12; C08G 18/22; C08G 18/48; C08G 18/66; C09D 11/033; C09D 11/037; C09D 11/102

(52) U.S. Cl. CPC C08G 18/3206; C08G 18/0852; C08G 18/12; C08G 18/227; C08G 18/4825; C08G 18/6674; C09D 11/033; C09D 11/037; C09D 11/102; C08G 2150/00

(57) ABSTRACT

Described herein are solvent-based polyurethane polymers having equal to or greater than 50% bio-based carbon content (% BRC). The solvent-based polyurethanes are prepared using bio-based raw materials, such as bio-based polyols. Lamination inks comprising the polyurethanes described herein have lamination bond strengths as good as or better than currently available non-BRC or low-BRC inks.

### CROSS REFERENCE TO RELATED APPLICATIONS

The present application claims priority to U.S. Provisional Application No. 63/391,047, filed 21 Jul. 2022, which is hereby incorporated in its entirety.

### FIELD OF THE INVENTION

The present invention is related to solvent-based polyurethane laminating printing inks. The polyurethane polymers prepared in the present application have at least 50% bio-renewable carbon content (% BRC), based on the total carbon content of the polyurethane polymer. Inks made with the inventive polyurethane polymers also have a high % BRC.

### BACKGROUND OF THE INVENTION

Due to ongoing brand owner demand for sustainable packaging materials, polyurethanes (PUs) with high bio-renewable content (BRC) continue to be of interest. Furthermore, it has been suggested that making bio-based PUs and using them in place of current petrochemical-based PUs is an effective route to reduce carbon footprint.

Due to the high cost and shortage of the biobased raw materials, the current commercially available bio-based polyurethane polymers only have up to 50% of BRC. Furthermore most of these commercially available bio-based polyurethane polymers with relatively low BRC are not suitable for use in printing inks as they do not have the requisite adhesion and resistance properties as non-biobased polyurethane polymers.

U.S. Pat. No. 8,952,093 discloses bio-based polyurethane dispersion compositions and methods. The disclosure relates to water-dispersible polyurethane polymers as well as related polyurethane dispersion (PUD) compositions including the same, methods of making the same, methods of using the same, and articles coated with the same. The water-dispersible polyurethane polymer includes hydrophobic oligomeric polyether soft segments that include 1,2-di-substituted oxyethylene repeating units. The 1,2-di-substituted oxyethylene repeating units are derived from unsaturated fatty acid esters, such as from a distribution of epoxidized vegetable oil fatty acid esters subjected to a ring-opening polymerization process for oligomeric polyether polyol formation. The water-dispersible polyurethane polymer further includes hard segments common to other PUD compositions. The reference refers to water-based and not for solvent-based laminating inks.

EP 3137530A1 discloses curable aqueous polyurethane dispersions made from renewable resources. The curable aqueous polyurethane dispersion is formed by reacting a polyol component with a polyisocyanate. The polyol component comprises at least one non-ionic polyol, at least one polyol bearing at least one ionic or potentially ionic group comprising an acid group or salt thereof and at least one ethylenically unsaturated monoalcohol or polyol. The polyol component contains carbon atoms from renewable resources. A method for making the curable aqueous polyurethane dispersion, uses of the aqueous polyurethane dispersion, cured polyurethanes and nail polish formulations comprising aqueous polyurethane dispersions are also disclosed. The reference relates to water-based and not for laminating inks.

U.S. Pat. Nos. 11,421,077 and 11,597,793 disclose bio-based and hydrophilic polyurethane prepolymers prepared using the cleaned bio-based polyoxyalkylene glycol polyols. The bio-based polyurethane prepolymers are used to make polyurethane foam. There is no disclosure of the use of the bio-based polyurethane prepolymers being used to prepare inks.

U.S. Pat. No. 11,530,332 discloses bio-based aqueous polyurethane dispersions. The dispersions comprise particles of polyurethane in water, wherein the polyurethane is derived from an organic diisocyanate, a hydrophilic monomer, a neutralizer, and a chain extender; and a polyester resin. The bio-based aqueous polyurethane dispersion is useful for plant-based leather alternatives, coatings, adhesives and sheet materials. Although use of polyurethane dispersions in inks is mentioned in the background, there is no teaching of an ink formulation, and there is no disclosure of laminating inks.

Ha and colleagues (Ha et al. (2023). Bio-based waterborne polyurethane coatings with high transparency, antismudge and anticorrosive properties. ACS Appl. Mater. Interfaces 15(5): 7427-7441) disclose a waterborne polyurethane (WPU) coating grafted with a minor proportion of poly(dimethylsiloxane) (WPU-g-PDMS). The WPU-g-PDMS coatings exhibit both dispersion stability, while also having high transparency, anticorrosive, and antismudge properties.

CN 11333691 discloses a bio-based polyurethane water-based ink comprising: bio-based isocyanate, bio-based macromolecular polyol, polypropylene carbonate polyol, a carboxylic acid type hydrophilic chain extender, a sulfonic acid type hydrophilic chain extender and a cross-linking agent.

CN 114181357 discloses a bio-based solvent-free waterborne polyurethane emulsion, and a gravure printing ink for flexible food packaging comprising said polyurethane emulsion. Bio-based polyhydric alcohol is used as a raw material to prepare the polyurethane.

Zhang and colleagues (Zhang et al. (2015). Biobased polyurethanes prepared from different vegetable oils. ACS Appl. Mater. Interfaces 7(2):1226-1233) disclose a series of bio-based polyols prepared from olive, canola, grape seed, and castor oil using a novel solvent/catalyst-free synthetic method. They also disclose polyurethanes prepared using the bio-based polyols.

Schneiderman and colleagues (Schneiderman et al. (2016). Chemically recyclable biobased polyurethanes. ACS Macro. Lett. 5(4): 515-518) disclose the synthesis of biobased and chemically recyclable polyurethanes, using renewable and degradable hydroxyl telechelic poly(β-methyl-δ-valerolactone) as a replacement for petroleum-derived polyols.

Konieczny and Loos (Konieczny and Loos (2019). Green polyurethanes from renewable isocyanates and biobased white dextrins. Polymers, 11: 256) disclose bio-based polyurethanes prepared using bio-based ethyl ester L-lysine diisocyanate (LLDIO and ethyl ester L-lysine triisocyanate (LLTI), isophorone diisocyanate (IPDI), and a bio-based white dextrin as a crosslinker.

Lacruz and colleagues (Lacruz et al. (2021). Biobased Waterborne Polyurethane-Ureas Modified with POSS—OH for Fluorine-Free Hydrophobic Textile Coatings. Polymers, 13: 3526) disclose waterborne polyurethane-urea dispersions (WPUD), which are based on fully biobased amorphous polyester polyol and isophorone diisocyanate (IPDI).

Hai and colleagues provide a review of polyurethanes made using bio-based materials (Hai et al. (2021). Renewable Polyurethanes from Sustainable Biological Precursors. Biomacromolecules, 22(5): 1770-1794).

US 2021/0115278 discloses a solvent-borne bio-polyurethane resin obtained by reacting a polyester bio-polyol component (A) with an isocyanate component component (B). The polyester bio-polylol is an essential component. The polyester bio-polyol is synthesized using a dicarboxylic acid and a diol. A dicarboxylic acid is a necessary component. The only mention of inclusion of a polyether polyol is as an additional petroleum-based polyol. Also described is a bio-polyurethane resin solution comprising the bio-polyurethane and an organic solvent. Printing inks comprising the bio-polyurethane are also disclosed. The bio-based polyurethane of US 2021/0115278 are polyester polyurethanes, and therefore would not be suitable for use in lamination inks, because polyester polyurethanes are brittle at lower temperatures.

Citation or identification of any document in this application is not an admission that such represents prior art to the present invention.

### BRIEF SUMMARY OF THE INVENTION

The present invention provides polyether polyurethane polymers having a high bio-renewable carbon content (% BRC). Also disclosed are inks that are suitable to use as laminating inks in laminate film structures.

In a particular aspect, the present invention provides a solvent-borne polyurethane or polyurethane/urea polymer formed by:
(a) preparing a polyurethane or polyurethane/urea prepolymer by reacting:
   i. one or more bio-based polyether polyols, bio-based dimer diols, bio-based low molecular weight diols, or bio-based low molecular weight polyols, or combinations thereof; wherein the polyols and diols do not contain any dicarboxylic acid moieties; and
   ii. one or more polyisocyanates, having two or more isocyanate groups;
wherein the amount of unreacted isocyanate (NCO %) of the pre-polymer is 0.1 to 3.0; and
(b) chain extending the polyurethane by reaction with a chain extender selected from one or more bio-based monoamines, polyamines, alcohols, or polyols;
   wherein the % bio-renewable carbon (% BRC) of the polyurethane polymer is equal to or greater than 50%.

In another aspect, the present invention provides lamination inks comprising the polyurethane or polyurethane/urea polymers of the present invention. The present invention also provides laminated articles comprising the lamination inks of the present invention.

In another aspect, the present invention provides a method of preparing a laminated article, comprising:
(a) providing a first substrate and a second substrate;
(b) applying the solvent-based lamination ink of the present invention to the first substrate;
(c) drying the solvent-based lamination ink on the first substrate;
(d) applying a layer of an adhesive composition on top of the ink dried on the first substrate; and
(e) placing the second substrate in contact with the adhesive composition to adhere the second substrate to the first substrate;
   wherein the solvent-based lamination ink has a lamination bond strength equal to or greater than 1.0 N/15 mm.

These and other objects, advantages, and features of the invention will become apparent to those persons skilled in the art upon reading the details of the formulations and methods as more fully described below.

### DETAILED DESCRIPTION OF THE INVENTION

The present invention provides solvent-borne polyether polyurethane polymers having a bio-renewable carbon content (% BRC) of at least 50%, and preferably as high as 90%. The polyether polyurethanes are suitable to be used in solvent-based lamination inks, resulting in finished inks with a higher % BRC content than is currently available.

It is to be understood that the foregoing general description and the following detailed description are exemplary and explanatory only, and are not restrictive of any subject matter claimed.

Headings are used solely for organizational purposes, and are not intended to limit the invention in any way.

Unless otherwise defined, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose. Although any methods and materials similar or equivalent to those described herein can be used in the practice or testing of the present invention, the preferred methods are described.

### Definitions

In this application, the use of the singular includes the plural unless specifically stated otherwise. As used herein, the singular forms “a,” “an” and “the” are intended to include the plural forms as well, unless the context clearly indicates otherwise.

In this application, the use of “or” means “and/or” unless stated otherwise. Also, when it is clear from the context in which it is used, “and” may be interpreted as “or,” such as in a list of alternatives where it is not possible for all to be true or present at once.

As used herein, the terms “comprises” and/or “comprising” specify the presence of the stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composed,” “comprised” or variants thereof are used in either the detailed description or the claims, such terms are intended to be inclusive in a manner similar to the term “comprising.”

When the terms “consist of”, “consists of” or “consisting of” is used in the body of a claim, the claim term set off with “consist of”, “consists of” and/or “consisting of” is limited to the elements recited immediately following “consist of”, “consists of” and/or “consisting of”, and is closed to unrecited elements related to that particular claim term. The term ‘combinations thereof’, when included in the listing of the recited elements that follow “consist of”, “consists of” and/or “consisting of” means a combination of only two or more of the elements recited.

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

It is to be understood that wherein a numerical range is recited, it includes the end points, all values within that range, and all narrower ranges within that range, whether specifically recited or not.

Throughout this disclosure, all parts and percentages are by weight (wt % or mass % based on the total weight) and all temperatures are in ° C. unless otherwise indicated.

As used herein, “substrate” means any surface or object to which an ink or coating can be applied. Substrates include, but are not limited to, cellulose-based substrates, paper, paperboard, fabric (e.g. cotton), leather, textiles, felt, concrete, masonry, stone, plastic, plastic or polymer film, spunbond non-woven fabrics (e.g. consisting of polypropylene, polyester, and the like) glass, ceramic, metal, wood, composites, combinations thereof, and the like. Substrates may have one or more layers of metals or metal oxides, or other inorganic materials. Particularly preferred are non-woven substrates.

As used herein, the term “article” or “articles” means a substrate or product of manufacture. Examples of articles include, but are not limited to: substrates such as cellulose-based substrates, paper, paperboard, plastic, plastic or polymer film, glass, ceramic, metal, composites, and the like; and products of manufacture such as publications (e.g. brochures), labels, and packaging materials (e.g. cardboard sheet or corrugated board), containers (e.g. bottles, cans), a polyolefin (e.g. polyethylene or polypropylene), a polyester (e.g. polyethylene terephthalate), a metalized foil (e.g. laminated aluminum foil), metalized polyester, a metal container, and the like.

As used herein, “inks and coatings,” “inks,” and “coatings” are used interchangeably, and refer to compositions of the invention, or, when specified, compositions found in the prior art (comparative). Inks and coatings typically contain resins, solvent, and, optionally, colorants. Coatings are often thought of as being colorless or clear, while inks typically include a colorant.

As used herein, “natural material(s)” are materials that are botanic (plant-based), mineral-based, of animal original, derived from microorganisms, their reaction products, and combinations thereof, and water. Natural materials may be used as they occur in nature, or they can undergo processing that does not significantly alter the original physical, chemical, or biological state of the ingredient. Examples of permissible processing include dehydration, extraction, extrusion, centrifugation, filtration, distillation, grinding, sieving, compression, freezing, drying, milling, etc. Natural materials include, but are not limited to, water, natural resins, natural defoamers, natural waxes, natural colorants, bio-solvents, natural minerals, and the like.

As used herein, “BRC” refers to bio-renewable content or bio-renewable carbon, which can further be defined as non-ancient carbon (i.e. non-fossil-based carbon) that is part of earth's natural environment. Non-ancient carbon (less than 40,000 years after final atmospheric carbon incorporation) contains radiocarbon (¹⁴C), whereas ancient (fossil-based) carbon does not contain radiocarbon. BRC refers to naturally occurring renewable resources that can be replenished to replace the portion depleted by usage and consumption, either through natural reproduction, or other recurring processes in a finite amount of time (such as within a human lifetime).

The bio-based carbon content (BRC) is generally determined using the standard method described in ASTM D6866 (“Standard Test Methods for Determining the Biobased Content of Natural Range Materials Using Radiocarbon and Isotope Ratio Mass Spectrometry Analysis”). See “Understanding biobased carbon content,” Society of the Plastics Industry Bioplastics Council (February 2012). The application of ASTM D6866 to measure “bio-based content” is based on the same concepts as radiocarbon dating, but without using the age equations. The ratio of the amount of radiocarbon (14C) in an unknown sample to that of a modern reference standard is determined. Fossil carbon contains no radiocarbon. The greater the amount of “new” carbon, the higher 14C. The ratio is reported as a percentage of the total carbon that is modern carbon, with the units “pMC” (percent modern carbon), or BRC (as a percentage i.e. % BRC=[bio-renewable carbons/(bio-renewable carbons+fossil carbons)]×100). Some suppliers may assess a percentage of biobased content based on weight, based on the “recipe” the producer uses (i.e. how much of a natural material, such as cellulose, is present in a varnish containing cellulose and copolyester). For the purposes of the present invention, the % BRC of a raw material is quoted by the manufacturer and/or supplier. This is incorporated into a calculation based on the % of the specific raw material in the 100% wet ink composition. From this, and knowing the total non-volatile (i.e. solid) content (% NVC), it can be calculated and expressed as % BRC of the total % NVC.

As used herein, “plant-based” refers to materials that contain equal to or greater than 50% of the ingredient mass from plant-based sources.

As used herein, “naturally derived” refers to materials with equal to or greater than 50% natural or biobased origin by molecular weight, based on renewable carbon content.

As used herein, “bio-based” refers to materials containing carbon of renewable origin from agricultural, plant, animal, fungi, microorganisms, marine, or forestry materials.

As used herein, “renewable” refers to materials that are part of earth's natural environment. Renewable resources are naturally occurring, and can be replenished to replace the portion depleted by usage and consumption, either through natural reproduction or other recurring processes, in a finite amount of time (such as within a human lifetime).

As used herein, “sustainable” refers to the quality of not being harmful to the environment or depleting natural resources, and thereby supporting long-term ecological balance.

As used herein, “% NCO” refers to the amount of unreacted isocyanate groups on the polyurethane pre-polymer. The % NCO of the pre-polymer is generally between 0.1 and 3.0, preferably 1.30 to 1.50.

As used herein, “amine value” or “amine number” refers to the measure of the amine group content in one gram of polymer. Amine value is measured by titrating a known mass of polymer against hydrochloric acid, and is expressed as mg KOH/g.

As used herein, “lamination bond strength” refers to the amount of force required to separate substrates which are adhered to each other. Lamination bond strength is typically expressed as N/15 mm.

As used herein, “low molecular weight diol” and “low molecular weight polyol” refer to diols and polyols have a number average molecular weight (Mn) of less than or equal to 2000 Daltons, and a weight average molecular weight (Mw) of less than or equal to 5000 Daltons.

It is to be understood that “polyurethane” and “polyurethane/urea” both refer to the polyurethane polymers of the present invention, and may be used interchangeably. This is because when an amine is used as a chain extender the polymer may have both urethane and urea bonds, depending on the reaction conditions.

### Polyurethane Polymers and Inks Prepared Using the Polyurethane Polymers

It is the intention of the present application to expand the % BRC of polyurethane and/or polyurethane/urea polymers to greater than 50%, for example equal to or greater than 53%, equal to or greater than 60%, equal to or greater than 70%, equal to or greater than 80%, and as high as 90%. Use of these polyurethane polymers in inks also results in finished inks with higher % BRC content. As can be seen in the Examples below (Tables 1 and 2), the inventive polyurethanes (used in Examples 7 and 10) imparted a significant increase in % BRC when used in lamination inks when compared to lamination inks based on traditional petroleum-based polyurethanes (Comparative Examples 5 and 8), as well as lamination inks based on currently available “renewable” polyurethanes. The data indicate a % BRC increase of between double and treble over traditional polyurethanes, and a 20% to 30% increase over currently available renewable polyurethanes.

The inventors used bio-based raw materials to develop/synthesize a higher % BRC polyether polyurethane polymer. This polyurethane can be used to formulate solvent based laminating inks with equivalent performance to current non-biobased polyurethane laminating inks. One important feature is that the inventive inks have lamination bond strength that are similar to non-biobased equivalents.

The inventors were able to provide an inventive polyurethane that can be used as a laminating ink vehicle with excellent lamination bond strengths. Other bio-based polyurethanes are not ideally suitable for laminating ink because they either do not have the proper lamination bond values, or do not contain a high % BRC. For example, one commercially available polyurethane (Stahl PU 585) can be used to formulate a good laminating ink, but it only about 50% BRC. Conversely, the inventors were able to expand % BRC of polyurethane polymers to greater than 50%, for example equal to or greater than 53%, equal to or greater than 60%, equal to or greater than 70%, equal to or greater than 80%, and as high as 90%, while maintaining good lamination bond values.

### Polyurethane Polymer

A polyurethane polymer has units derived from isocyanates, alcohols, and a chain extender, such as a polyamine or glycol. Generally, it is preferred that the isocyanate has two or more isocyanate functional groups (polyisocyanate), and that the alcohol has two or more hydroxyl groups (polyol). Polyurethanes characteristically have a urethane linkage (NH—(C═O)—O). In some embodiments, when a polyamine is used as the extension agent, the polymer may also have urea bonds (The general reaction for the synthesis of polyurethane is an addition reaction between a polyisocyanate and a polyol.

The polyol forms the soft segment of the polyurethane, and the type of polyol used affects the properties of the polyurethane. For example, an elastic polyurethane can be obtained by using a polyol with a linear structure and high molecular weight, with a low functionality. A rigid polyurethane can be synthesized using a polyol with aromatic groups in the structure, low molecular weight, and higher functionality (the higher functionality promotes crosslinking). The type of polyol also affects the structure and properties—polyether, polyester, and polycarbonate polyols are examples of types of polyols that can be used. The isocyanate and chain extender forms the hard segment of the polyurethane, and the type of isocyanate affects the physical properties of the polyurethane, such as strength and rigidity through physical crosslinking points. Depending on the ratio of starting materials used, polyurethanes may have isocyanate terminal groups (excess of isocyanate), or hydroxyl terminal groups (excess of polyol). Isocyanate terminated polyurethanes are generally hydrophobic, chemically stable, and more rigid. On the other hand, polyurethanes with hydroxyl terminal groups are hydrophilic, susceptible to external agents, and flexible.

The polyurethane of the present invention is described herein.

### Isocyanate

For the synthesis of polyurethane, two types of isocyanates are generally used, aliphatic and aromatic. Aromatic isocyanates provide rigid segments to the structure, and are used mostly in the synthesis of rigid and thermoset polyurethanes. Aliphatic isocyanates are commonly used in coatings because they mix well with pigments, retain gloss, and are UV stabilized.

As used herein, the term “aliphatic isocyanate” is understood to comprise straight or branched chain aliphatic as well as cycloaliphatic isocyanates. Generally, aliphatic isocyanates having two or more isocyanate functional groups are preferred, and diisocyanates are most preferred. Preferably, the aliphatic isocyanate comprises 3 to about 10 carbon atoms. Examples of suitable aliphatic isocyanates include, but are not limited to: 1,4-diisocyanatobutane; 1,6-diisocyanatohexane; 1,5-diisocyanato-2,2-dimethylpentane; 4-trimethyl-1,6-diisocyanatohexane; 1,10-diisocyanatodecane; 1,3-diisocyanatocyclo-hexane; 1,4-diisocyanatocyclo-hexane; 1-isocyanato-5-isocyanatomethyl-3,3,5-trimethylcyclohexane; isophorone diisocyanate (IPDI); 2,3-diisocyanato-1-methylcyclohexane; 2,4-diisocyanato-1-methylcyclohexane; 2,6-diisocyanato-1-methylcyclohexane; 4,4′-diisocyanatodicyclohexylmethane; 2,4′-diisocyanatodicyclohexylmethane; 1-isocyanato-3-(4)-isocyanatomethyl-1-methyl-cyclohexane; 4,4′-diisocyanatodiphenylmethane; 2,4′-diisocyanatodiphenylmethane; 2,2,4-trimethyldiisocyanatohexane; 2,4,4 trimethyldiisocyanatohexane; and mixtures thereof. The above listed aliphatic isocyanates are mostly not high BRC materials, however they can be used in combination with high BRC materials such that the final BRC of the polyurethane is ≥50%, for example ≥53%, ≥60%, ≥70%, ≥80%, ≥90%.

As used herein, the term “aromatic isocyanate” is to be understood to include both aromatic as well as cycloaromatic isocyanates, which may also include aliphatic moieties. Generally, aromatic isocyanates having two or more isocyanate functional groups are preferred, and diisocyanates are most preferred. Preferably, the aromatic isocyanate comprises 5 to about 10 carbon atoms. Examples of suitable aromatic isocyanates include, but are not limited to: 1,1′-methylenebis[4-isocyanato-benzene](MDI); 1,3-diisocyanatomethyl-benzene (TDI); and blends thereof.

The isocyanates may be used alone, or as a combination of two or more.

Examples of isocyanates that can be used in the synthesis of the polyurethanes of the present invention include, but are not limited to, VESTANAT IPDI (isophorone diisocyanate) and VESTANAT IPDI eCO (isophorone diisocyanate having about 75% BRC), both from Evonik.

### Polyol

In the present invention, it is preferred that alcohols having two or more hydroxyl functional groups (polyols) are used to synthesize the polyurethane. Examples of diols include, but are not limited to: the polyethylene glycols (PEG); polypropylene glycols (PPG); dimethylolpropionic acid (DMPA); polytetramethylene ether glycols (Poly-THF); 1,3-propanediol (PDO); 1,4-butanediol(BDO); 1,6-hexanediol; neopentyl glycol; as well as mixtures thereof. The above listed polyols are mostly not high BRC materials, however they can be used in combination with high BRC materials such that the final BRC of the polyurethane is ≥50%, for example ≥53%, ≥60%, ≥70%, ≥80% and ≥90%. Preferred polyols include bio-based polyether polyols, bio-based dimer diols, bio-based low molecular weight diols, or bio-based low molecular weight polyols, or combinations thereof.

In preferred embodiments, the polyols used are bio-based. Non-limiting examples of bio-based polyols are those derived from bio-based oils; oils derived from animal fats; derived from sugars (sugar alcohols, e.g. sorbitol, mannitol, erythritol, xylitol, ethylene glycol, glycerol, etc.); polyols made from bio-based diol 1,3-propanediol (PDO); polyols made from bio-based butanediol (BDO); glycerol monooleate; or polyols derived from dimer fatty diacid residues and dimer fatty diol residues. In some embodiments, the bio-based polyol is derived from bio-based oils selected from vegetable or seed oils, soy bean oil, rapeseed oil, canola oil, peanut oil, cotton seed oil, sunflower oil, olive oil, grape seed oil, linseed oil, castor oil, fish oils, algal oils, or mustard seed oils.

The polyols used in the present invention do not include any dicarboxylic acid moieties, and are not prepared using dicarboxylic acids.

In one embodiment, the polyol is Velvetol H500 (1,3-propanediol), which is 100% bio-based (WeylChem). In another embodiment, the polyol is Radiasurf 7150, which is 100% bio-based (Oleon). Radiasurf 7150 is a mixture of bio-based glycerol mono oleate, dioleates, trioleates and glycerol. In another embodiment, the polyol may be the bio-based dimer diol Pripol 2033, which is also 100% bio-based (Croda) is used in the pre-polymer synthesis.

### Chain Extension Agent

A chain extension agent (sometimes referred to as a chain extender) is a compound that can react with a residual isocyanate group of a polyisocyanate unit of a urethane preolymer. The residual isocyanate group is an isocyanate group that did not form a urethane bond. In one embodiment, a chain extension agent may be used in the synthesis of the poly(urethane/urea) polymer. The chain extension reaction is carried out with 80% to 120% equivalents of the chain extension agent (e.g. diamine), based on the equivalents of unreacted NCO groups on the prepolymer to form the solvent soluble poly(urethane/urea). When an amine, such as a diamine, is used as the chain extension agent, the diamine reacts with the isocyanates to form both urethane bonds and, depending on the reaction conditions, urea bonds.

Chain extension agents include polyvalent amines and alcohols. In some embodiments, the chain extension agent is selected from polyvalent amine compounds; ethylene glycol; propylene glycol; 1,3-propanediol; 1,3-butanediol; 1,4-butanediol; 1,5-pentanediol; 1,6-hexanediol; neopentyl glycol; diethylene glycol; triethylene glycol; tetraethylene glycol; dipropylene glycol; tripropylene glycol; poly(ethylene glycol); 3-methyl-1,5-pentanediol; 2-butyl-2-ethyl-1,3-propanediol; 1,4-cyclohexanediol; 1,4-cyclohexanedimethanol; hydrogenated bisphenol A; glycerin; trimethylolpropane; pentaerythritol; and mixtures thereof. In some embodiments, the polyvalent amine compound is selected from: dimer diamine (Priamine™ 1075), trimethylolmelamine and derivatives thereof; dimethylolurea and derivatives thereof; dimethylolethylamine, diethanolmethylamine; dipropanolethylamine; dibutanolmethylamine; ethylenediamine; propylenediamine; diethylenetriamine; hexylenediamine; triethylenetetramine; tetraethylenepentamine; isophoronediamine; xylylenediamine; diphenylmethanediamine; hydrogenated diphenylmethanediamine; hydrazine; polyamide polyamine; polyethylene polyimine; and combinations thereof. The above listed chain extension agents are mostly not high BRC materials, however they can be used in combination with high BRC materials such that the final BRC of the polyurethane is ≥50%, for example ≥53%, ≥60%, ≥70%, ≥80%, ≥90%. These chain extension agents may be used alone or in a combination of two or more.

In one embodiment, the bio-based dimer diamine Priamine 1075, which is 100% bio-based (Croda) is used in the pre-polymer extension.

### Laminating Inks and Laminates Prepared Using the Inks

The polyurethanes disclosed herein are suitable for use in laminating inks. Inks suitable for laminating should have good adhesion to the printed substrate, allowing scratch and scuff free printing prior to laminating. The ink must accept the laminating adhesive to form a bond between the substrates.

Laminating inks of the present invention typically comprise about 10 wt % to 50 wt % of a polyurethane dispersion/solution of the present invention, based on the total weight of the ink. For example, laminating inks may comprise about 15% to 30% of a polyurethane dispersion of the present invention, preferably 20% to 25%.

The finished inks of the invention preferably have from about 10% to about 70% BRC, on a solid weight basis. For example, the finished inks of the invention have about 10% to about 50% BRC, on a solid weight basis. In preferred embodiments, the finished ink will have about 20% to about 50% BRC, on a solid weight basis.

The polyurethane dispersions/solutions of the present invention typically have about 10% to about 70% resin solids (% NVC). Preferably, the polyurethane solutions of the present invention have about 30 wt % to about 65 wt % solids. The amount of polyurethane solids in an ink is calculated from the amount of the dispersion multiplied by the amount of resin solids. For example, an ink containing 50 wt % of a polyurethane dispersion, based on the total weight of the ink, and the polyurethane had 50% solids, then the amount of polyurethane resin solids in the ink would be 50(0.5)=25 wt %, based on the total weight of the ink. If the total solids in the ink was 50%, then the proportion of solids that is polyurethane would be (25/50)×100=50 wt %, based on the total solids. If the polyurethane had 50% BRC, then the ink would have 50(0.5)=25% BRC on a solid weight basis.

The laminating inks of the present may also comprise one or more colorants. Suitable colorants include but are not limited to: organic or inorganic pigments and dyes. The dyes include but are not limited to fluorescent dyes, azo dyes, anthraquinone dyes, xanthene dyes, azine dyes, combinations thereof and the like. Organic pigments may be one pigment or a combination of pigments, such as for instance Pigment Yellow Numbers 12, 13, 14, 17, 74, 83, 114, 126, 127, 174, 188; Pigment Red Numbers 2, 22, 23, 48:1, 48:2, 52, 52:1, 53, 57:1, 112, 122, 166, 170, 184, 202, 266, 269; Pigment Orange Numbers 5, 16, 34, 36; Pigment Blue Numbers 15, 15:3, 15:4; Pigment Violet Numbers 3, 23, 27; and/or Pigment Green Number 7. Inorganic pigments may be one of the following non-limiting pigments: iron oxides, titanium dioxides, chromium oxides, ferric ammonium ferrocyanides, ferric oxide blacks, Pigment Black Number 7 and/or Pigment White Numbers 6 and 7. Other organic and inorganic pigments and dyes can also be employed, as well as combinations that achieve the colors desired. Inorganic and organic pigments may be added as a solid, or as a dispersion. A pigment dispersion may comprise about 10% to about 50% solids. Typically, colorants are included in the laminating inks in an amount of about 5 wt % to about 70 wt %, on a solid weight basis.

The laminating inks of the invention typically comprise one or more organic solvents. Suitable solvents include, but are not limited to, alcohols, esters, ethers, acetates, glycols, glycol ethers, glycol ether acetates, hydrocarbons, aromatic hydrocarbons, combinations thereof, and the like. In certain embodiments, the solvents include toluene, isopropanol, ethoxy propanol, ethanol, ethyl acetate, or combinations thereof. The solvents may be added solvents, or may be included as part of materials (e.g. dispersions) used in the ink formulation. Solvents are typically present in an amount of about 10 wt % to about 80 wt %, based on the total weight of the ink composition.

As with most ink and coating compositions, additives may be incorporated to enhance various properties. A partial list of such additives includes but is not limited to adhesion promoters, silicones, light stabilizers, optical brighteners, de-gassing additives, ammonia, flow promoters, defoamers, antioxidants, stabilizers, surfactants, dispersants, plasticizers, rheological additives, waxes, silicones, etc. When present, the additives are each individually present in an amount of about 0.1 wt % to about 10 wt %.

The laminating inks of the invention may comprise the usual extenders such as clay, talc, calcium carbonate, magnesium carbonate or silica to adjust water uptake, misting and color strength. When present, the extenders are typically present in an amount of about 0.5 wt % to about 5 wt %.

To prepare a laminated article, a finished ink of the invention, comprising the polyurethane of the invention, is applied to a first substrate, and dried on the substrate. An adhesive is applied on top of the dried ink, and a second substrate is adhered to the first substrate. The laminated article may have additional substrate layers, one or more of which are optionally printed with a finished ink of the invention.

In certain embodiments, the laminating inks of the invention have a lamination bond strength of equal to or greater than 1.0 N/15 mm. Preferably, the lamination bond strength is equal to or greater than 1.5, or 1.75, or 2.0 N/15 mm. Depending on the structure of the lamination and the mode of failure, the bond value should be above 1.5 N/15 mm.

### EXAMPLES

The present invention is further described by the following non-limiting examples, which further illustrate the invention, and are not intended to, nor should they be interpreted to, limit the scope of the invention.

### Methods

### Percent Isocyanate (NCO %)

The amount of unreacted isocyanate in the prepolymer was measured by acid/base titration by back-titration with an excess of di-n-butylamine, using a Mettler Toledo Titration T5 auto titrator. Before testing a sample, an isocyanate blank is run, using the isocyanate blank method.

Blank measurement: 30 ml of toluene, or other appropriate solvent, is added to a dry Erlenmeyer flask, and 20 ml of 2 N n-dibutylamine is added. This mixture is stirred for about 10 minutes, then 30 ml of methanol are added. This mixture was titrated with 1.0 N HCl acid solution to an equivalence point. The volume (ml) of HCl solution is recorded.

Sample measurement: Approximately 2 to 3 g of the isocyanate material (pre-polymer) was weighed into a dry Erlenmeyer flask. The weight was recorded to the nearest 0.01 g. Approximately 25 ml of toluene, or other appropriate solvent, was added to the flask. Then, exactly 10.0 ml of 2.0 N di-n-butylamine (in toluene) was pipetted into the flask. Once all the polymer was dissolved, approximately 30 ml of the indicator solution (bromocresol green in isopropanol) was added. The solution is then titrated with a 1.0 N HCl acid solution in water to equivalence, and the volume (ml) HCl solution is recorded. The % NCO is calculated according to the following:

$$\% NCO = ( 4.202 ) ( vol . HCl blank - vol . HCl sample ) / sample wt in g$$

### Amine Value

The amine value of the polyurethane polymer was assessed as the mass equivalent of potassium hydroxide that is required when one gram of substance is neutralized with a suitable acid (typically hydrochloric acid). The amine value is measured by means of acid/base titration of the amine nitrogen, i.e. amine basicity, content in a compound. Amine value is expressed in units of mg of KOH equivalent to the basic nitrogen content in a 1 g sample (mg KOH/g). A sample of the pre-polymer was weighed into an Erlenmeyer flask, and dissolved in an appropriate neutralized solvent (e.g. a 50/50 mixture of toluene and isopropyl alcohol). When the sample was dissolved, approximately 10 drops of indicator solution (e.g. crystal violet) was added. The mixture was titrated with 0.1 N HCl in water to color change. The volume (ml) of HCl was recorded. Amine value was calculated according to the following formula:

$$Amine value = ( 5.61 \times vol . HCl titrant ) / sample wt in g$$

### Viscosity

Viscosity measurements were taken using a Brookfield DV-3T viscometer, with spindle LV-3(63), at 60 rpm and 25° C. Viscosity is reported as cPs.

### Solids (Non-Volatile) Content of Polyurethane Solution

The solids (non-volatile) content of the solvent based polyurethane solution was measured using a vacuum oven. An empty pan was placed on an electronic balance, the pan weight was recorded, and the balance was tared. Approximately 1 g of sample was placed into the pan, and the weight of the wet sample was recorded after the balance reading stabilized. The pan was placed in a vacuum oven set at 120° C. (±1° C.). The oven door was closed, and vacuum applied. Once full vacuum was reached (approximately 28″ mercury (Hg)), the vacuum was maintained for 15 minutes. The pan was then removed from the oven and weighed, and the weight of the pan and the solids was recorded. The percent solids was calculated as follows:

{[(weight of pan and solids)−(weight of empty pan)]/(weight of wet sample)}×100

### % BRC

BRC of pre-polymer: % BRC of the raw materials was assessed using ASTM D6866-18 Method B, or provided by the manufacturer or supplier. For each material containing carbon used to synthesize the polyurethane polymer, the amount of carbon per gram (C/g) was calculated by dividing the number of carbons by the molecular weight. The mass of carbon (Cₘₐₛₛ) contributed to the composition was calculated by multiplying the C/g by the number of grams added to the composition. The sum of the Cₘₐₛₛ contributed by each material is the total mass of carbon (Cₜₒₜₐₗ) in the composition. The wt % of the total carbon contributed by each material (C_{wt %}) is (Cₘₐₛₛ/Cₜₒₜₐₗ)(100). The % BRC contributed by each material is (C_{w}t %)(% bio-based). For example, if a raw material contributes 13.02 wt % of the total carbon mass, and the raw material is 100% bio-based, then the % BRC contributed by that material is 13.02%. If a raw material contributes 13.02 wt % of the total carbon mass, and the raw material is 75% bio-based, then the % BRC contributed by that material is (13.02)(0.75)=9.77%. The total % BRC in the composition is the sum of the % BRC contributed by each raw material in the polyurethane resin.

BRC of finished ink: The total solids (% NVC) for each material, and the % BRC for each material was provided by the supplier. The BRC contribution to the % NVC of each material was calculated by multiplying the amount (wt %) of the material by the % BRC in the material. The total BRC NVC contribution % is the sum of the % BRC contributed from each material. The solids contribution of each material to the total solids was calculated by multiplying the amount (wt %) by the % NVC of the material. The total % NVC is the sum of the % NVC contributed from each material. The BRC % of the ink was calculated according to the following formula:

$$\% BRC of ink = ( total BRC NVC contribution \% / total NVC \% ) \times 100$$

### Lamination Bond Strength

Lamination bond strength was assessed according to the ASTM D903 test procedure, except that the consistent test sample size used was 15 mm×200 mm.

### Print Density

Print density was measured using an X-Rite “Exact NGH Spectrophotometer.” The measurement settings were D50 illumination, a 2° viewing angle, and MO measurement condition.

### Example 1. Synthesis of Polyurethane Solution 1

Polyurethane solution 1 was prepared as described below. The target NCO % for the pre-polymer was 1.30 to 1.50.

### Pre-Polymer Synthesis (Target NCO % 1.30 to 1.50):

A 1.0 L flask was charged with 69.4 g Pripol 2033 (dimer diol, 100% bio-based), 66.7 g Velvetol H500 (polyether polyol, 100% bio-based), 38.5 g 1,4-butanediol, 38.1 g Radiasurf 7150 (glycerol monooleate, 100% bio-based), and 200.0 g n-propyl acetate, and the mixture was mixed well. Then, the flask was charged with 187.3 g VESTANAT IPDI (3-isocyanatomethyl-3,5,5-trimethylcyclohexyl isocyanate), followed by 0.06 g K-Kat 348 catalyst (bismuth carboxylate catalyst). The mixture was then slowly heated to 80-85° C. The reaction was held at 80-85° C. until the pre-polymer NCO % reached 1.40-1.50%. The reaction was cooled to 40° C.

### Chain Extension and Solution Preparation:

A 2.0 L flask was charged with 75.0 g n-propanol and 59.8 g Priamine 1075 (dimer diamine, 100% bio-based), and mixed well at room temperature (i.e. about 21-25° C.). Then 525.0 g of the above pre-polymer solution was charged slowly into the flask over 10-20 minutes while mixing. A mixture of 56.0 g n-propanol and 56.0 g n-propyl acetate was then charged into the extended polyurethane solution.
Solids content=47.3%
Viscosity=2720 cPs
Amine value=1.3
% BRC˜53.69%

Note that, instead of VESTANAT IPDI, an alternative product, VESTANAT IPDI eCO (˜75% BRC) could be used instead, to produce a polyurethane with a BRC of ˜83.4%, without compromising bond strength properties.

### Example 2. Synthesis of Polyurethane Solution 2

Polyurethane solution 2 was prepared as described below. The target NCO % for the pre-polymer was 1.40 to 1.70.

### Pre-Polymer Synthesis:

L flask was charged 69.4 g Pripol 2033, 66.7 g Velvetol H500, 38.5 g 1,4-butanediol, 38.1 g Radiasurf 7150 and 200.0 g n-propyl acetate to mix well. Then, 187.3 g IPDI was charged, followed by 0.06 g K-Kat 348 catalyst. The mixture was then slowly heated to 80-85° C. The reaction was held at 80-85° C. until the pre-polymer NCO % reached 1.70-1.80.

### Chain Extension and Solution Preparation:

A 2.0 L flask was charged with 175.0 g n-propanol and 61.7 g Priamine 1075 and mixed well at room temperature. Then, the flask was charged slowly with 525.0 g of the above pre-polymer solution over 10-20 min while mixing. A mixture of 56.0 g n-propanol and 56.0 g n-propyl acetate was then charged into the extended polyurethane solution.
Solids=48.0%
Viscosity=1000 cPs
Amine value=3.3
% BRC˜54.95%

Note that, instead of VESTANAT IPDI, an alternative product, VESTANAT IPDI eCO (˜75% BRC) could be used instead, to produce a polyurethane with a BRC of ˜83.85%, without compromising bond strength properties.

### Example 3. Synthesis of Polyurethane Solution 3

Polyurethane solution 3 was prepared as described below. The target NCO % for the pre-polymer was 2.10-2.40.

### Pre-Polymer Synthesis:

A 1.0 L flask was charged with 69.4 g Pripol 2033, 66.7 g Velvetol H500, 38.5 g 1,4-butanediol, 38.1 g Radiasurf 7150 and 200.0 g n-propyl acetate, and mixed well. Then, 187.3 g VESTANAT IPDI was charged, followed by 0.06 g K-Kat 348 catalyst. The mixture was then slowly heated to 80-85° C. The reaction was held at 80-85° C. until the pre-polymer NCO % reaches 2.40-2.50%. The reaction was cooled to 40° C.

### Chain Extension and Solution Preparation:

A 2.0 L flask was charged with 175.0 g n-propanol and 84.6 g Priamine 1075 and mixed well at room temperature. Then, 525.0 g above pre-polymer solution was charged into the chain extension flask over 10-20 min while mixing. A mixture of 24.8 g n-propanol and 24.8 g n-propyl acetate was then charged into the extended polyurethane solution.
Solids=50.35
Viscosity=450 cPs
Amine value=1.2
% BRC=57.4%

Note that, instead of VESTANAT IPDI, an alternative product, VESTANAT IPDI eCO (˜75% BRC) could be used instead, to produce a polyurethane with a BRC of ˜84.73%, without compromising bond strength properties.

### Example 4. Synthesis of Polyurethane Solution 4

Polyurethane solution 4 was prepared as described below. The target NCO % for the pre-polymer was 2.10-2.40.

### Pre-Polymer Synthesis:

A 1.0 L flask was charged with 69.4 g Pripol 2033, 66.7 g Velvetol H500, 38.5 g 1,3-propanediol, 38.1 g Radiasurf 7150 and 200.0 g n-propyl acetate, and mixed well at room temperature. Then, 187.3 g VESTANAT IPDI was charged, followed by 0.06 g K-Kat 348 catalyst. The mixture was then slowly heated to 80-85° C. The reaction was held at 80-85° C. until the pre-polymer NCO % reached 2.40-2.5%. The reaction was cooled to 40° C.

### Chain Extension and Solution Preparation:

A 2.0 L flask was charged with 175.0 g n-propanol and 86.1 g Priamine 1075, and mixed well at room temperature. Then, 525.5 g above pre-polymer solution was charged slowly into the chain extension flask over 10-20 min while mixing. Then pre-mixed 25.0 g n-propanol and 25.0 g n-propyl acetate was charged into the extended polyurethane solution.
Solids=54.25%
Viscosity=310 cPs
Amine value=1.5
% BRC˜65.0

Note that, instead of VESTANAT IPDI, an alternative product, VESTANAT IPDI eCO (˜75% BRC) could be used instead, to produce a polyurethane with a BRC of ˜91.2%, without compromising bond strength properties.

### Examples 5 to 7. White Laminating Inks Comprising Polyurethane

The inventive polyurethanes were compared in white laminating inks based on commercially available non-BRC urethanes such as NeoRez U415 and U471 (Covestro) and also commercially available lower BRC urethanes such as PU585 (Stahl). These were compared at equal solids for print performance and lamination bond strength. Examples 5 and 6 are comparative examples, and Example 7 is an inventive example containing Example 2A polyurethane, which was prepared similar to Example 2 above, but the final BRC was 64.8%.

TABLE 1
Comparative Examples 5 and 6, and Inventive
Example 7 at equal PU NVC % (10.2%)

| | Ex. 5 | Ex. 6 | Ex. 7 |
|---|---|---|---|
| Material | (comp.) | (comp.) | (inv.) |
| TiO₂ pigment | 28.2 | 28.2 | 28.2 |
| Ultra-fine particle size, high | 4.2 | 4.2 | 4.2 |
| brightness kaolin | | | |
| Ethanol | 22.0 | 23.9 | 21.0 |
| Ethyl Acetate | 14.8 | 15.0 | 14.1 |
| 40% cellulose ester in 10% | 10.0 | 10.0 | 10.0 |
| Ethanol, 50% Ethyl Acetate | | | |
| Solution (total NVC 28.1%/ | | | |
| BRC 28.1%) | | | |
| Neorez U-471 (total NVC | 20.0 | — | — |
| 51%/BRC 0%) | | | |
| PE-Wax dispersion | 0.8 | 0.8 | 0.8 |
| STAHL PU 585, NVC 57% | — | 17.9 | — |
| (BRC 50%) | | | |
| Example 2A polyurethane | — | — | 21.7 |
| (total NVC 47.1%/BRC 64.8%) | | | |
| Total | 100.0 | 100.0 | 100.0 |
| BRC NVC Contribution % | 2.8% | 7.9% | 9.4% |
| Total NVC % | 45.7% | 45.8% | 45.8% |
| BRC % of Ink | 6.1% | 17.2% | 20.5% |

The data in Table 1 show that Example 7 inventive ink, prepared using Example 2A polyurethane of the present invention, has a higher % BRC than comparative inks Examples 5 and 6, using commercially available non-BRC polyurethanes, and commercially available bio-based polyurethanes having a lower % BRC than the high % BRC content polyurethanes of the present invention.

### Examples 8 to 10. Cyan Laminating Inks Comprising Polyurethane

The inventive polyurethanes were compared in cyan laminating inks based on commercially available non-BRC urethanes such as NeoRez U415 and U471 (Covestro) and also commercially available lower BRC urethanes such as PU585 (Stahl). These were compared at equal solids for print performance and lamination bond strength. Examples 8 and 9 are comparative examples, and Example 10 is an inventive example containing Example 2 polyurethane.

TABLE 2
Comparative Examples 8 and 9, and Inventive
Example 10 at equal PU NVC % (5.4%)

| | Ex. 8 | Ex. 9 | Ex. 10 |
|---|---|---|---|
| Material | (comp.) | (comp.) | (inv.) |
| Blue 15:4 NC Pigment Dispersion - | 53.2 | 53.2 | 53.2 |
| 5154NB0427 (total NVC 33.5%/BRC | | | |
| 6.0%) | | | |
| Ethanol | 11.3 | 11.3 | 10.0 |
| N Propanol | 8.8 | 8.8 | 8.0 |
| Ethoxy Propanol | 6.5 | 6.5 | 6.5 |
| Citrate Plasticizer | 0.7 | 0.7 | 0.7 |
| PE-Wax dispersion | 0.5 | 0.5 | 0.5 |
| Neorez U-415 (total NVC 57%/BRC 0%) | 9.4 | — | — |
| Titanate/Polyamide adhesion promoter | 2.0 | 2.0 | 2.0 |
| 40% cellulose ester in 10% Ethanol, 50% | 7.6 | 7.6 | 7.6 |
| Ethyl Acetate Solution (total NVC 28.1%/ | | | |
| BRC 28.1%) | | | |
| STAHL PU 585, total NVC 57% (BRC | — | 9.4 | — |
| 50%) | | | |
| Example 2A polyurethane (total NVC | — | | 11.5 |
| 47.1%/BRC 64.8%) | | | |
| Total | 100.0 | 100.0 | 100.0 |
| BRC NVC Contribution % | 5.3% | 7.9% | 8.8% |
| Total NVC % (solids) | 25.3% | 25.3% | 25.3% |
| BRC % of Ink | 20.9% | 31.2% | 34.8% |

The data in Table 2 show that Example 10 inventive ink, prepared using Example 2 polyurethane of the present invention, has a higher % BRC than comparative inks Examples 8 and 9, using commercially available non-BRC polyurethanes, and commercially available bio-based polyurethanes having a lower % BRC than the high % BRC content polyurethanes of the present invention.

### Example 11. Lamination Bond Strength of Inks

The inks (Examples 5 to 10) were printed by flexography onto an oriented polypropylene (OPP) substrate using a 3.5 cc volume anilox. The printed substrate was then laminated to a cast polypropylene (CPP) film using the solvent-based 2-art adhesive, Sapici LX545/IP70/ethyl acetate. Lamination bond strength was tested as described above. The results are shown in Table 3.

TABLE 3
Lamination bond strength

| | Average Bond |
|---|---|
| | Strength |
| Ink | N/15 mm |
| Ink 5 | 1.79 |
| Ink 6 | 1.77 |
| Ink 7 | 2.43 |
| Ink 8 | 1.88 |
| Ink 9 | 2.04 |
| Ink 10 | 2.20 |
| Ink 5 and Ink 8 | 1.23 |
| Combination | |
| Ink 6 and Ink 9 | 2.21 |
| Combination | |
| Ink 7 and Ink 10 | 3.00 |
| Combination | |

As shown in Table 3, lamination bond strength testing revealed that the inventive polyurethane gave a similar or improved bond strength to the commercial non-BRC polyurethane, and the lower BRC polyurethane. Advantageously, the bond strength would be equal to or greater than 1.00 N/15 mm, for examples greater than or equal to 1.50, or 1.75, or 2.00.

### Example 12. Print Density—Dot Gain

In addition to the above tests printability was also checked, and the inventive polyurethane shows advantages in print quality. White and cyan inks were printed onto 20 micron OPP substrate using a 3.3 cc anilox on a Soloflex flexographic press, at the same urethane solids and viscosity. The inks had a urethane solids of 5.4%, and viscosity of 24 seconds using a DIN cup #4 (˜70 cPs). Dot gain was measured as described below.

Print density of printed inks was measured as described above. Print densities of inks prepared using the inventive polyurethanes were compared to print densities of inks prepared with non-BRC and low BRC inks.

The measurements were taken from a vignette of reverse printed cyan ink over-printed with white ink. Initially the first result is the 100% tone, and the second reading is from the 2% area printed with cyan ink. The dot gain is the increase in density expressed as a percentage over the expected (standard non-BRC inks) 2% result—that is, the percentage over a standard non-BRC ink of the same color. The results are shown in Table 4.

TABLE 4
Print density

| | | 100% dot | 2% plate | 2% dot |
|---|---|---|---|---|
| | 100% plate | gain (% of | printing | gain (% of |
| | printing dot | standard) | dot | standard) |
| Standard white & | 0.68 | / | 19.20 | / |
| standard cyan ink | | | | |
| White and cyan | 0.79 | 116 | 21.20 | 110.4 |
| inks based on Stahl | | | | |
| PU 585 | | | | |
| White and cyan inks | 0.84 | 123.5 | 25.00 | 130.0 |
| based on Example | | | | |
| 2 PU | | | | |

For the inks based on Stahl PU 485 (low BRC), the 100% dot gain is 116% that of the standard inks, and the 2% dot gain is 110.4% of the standard inks. For the inventive inks based on Example 2 polyurethane, the 100% dot gain is 123.5% that of the standard inks, and the 2% dot gain is 130.0% that of the standard inks.

The present invention has been described in detail, including the preferred embodiments thereof. However, it will be appreciated that those skilled in the art, upon consideration of the present disclosure, may make modifications and/or improvements on this invention that fall within the scope and spirit of the invention.

1. A solvent-borne polyurethane or polyurethane/urea polymer, formed by:
(a) preparing a polyurethane or polyurethane/urea prepolymer by reacting:
i. one or more bio-based polyether polyols, bio-based dimer diols, bio-based low molecular weight diols, or bio-based low molecular weight polyols, or combinations thereof; wherein the polyols and diols do not contain any dicarboxylic acid moieties; and
ii. one or more polyisocyanates, having two or more isocyanate groups; wherein the polyisocyanate is selected from the group consisting of 1,4-diisocyanatobutane; 1,6-diisocyanatohexane; 1,5-diisocyanato-2,2-dimethylpentane; 4-trimethyl-1,6-diisocyanatohexane; 1,10-diisocyanatodecane; 1,3-diisocyanatocyclo-hexane; 1,4-diisocyanatocyclo-hexane; 1-isocyanato-5-isocyanatomethyl-3,3,5-trimethylcyclohexane; isophorone diisocyanate (IPDI); 2,3-diisocyanato-1-methylcyclohexane; 2,4-diisocyanato-1-methylcyclohexane; 2,6-diisocyanato-1-methylcyclohexane; 4,4′-diisocyanatodicyclohexylmethane; 2,4′-diisocyanatodicyclohexylmethane; 1-isocyanato-3-(4)-isocyanatomethyl-1-methyl-cyclohexane; 4,4′-diisocyanatodiphenylmethane; 2,4′-diisocyanatodiphenylmethane; 2,2,4-trimethyldiisocyanatohexane; 2,4,4 trimethyldiisocyanatohexane; 1,1′-methylenebis[4-isocyanato-benzene](MDI); 1,3-diisocyanatomethyl-benzene (TDI); and blends thereof; and
wherein the amount of unreacted isocyanate (NCO %) of the pre-polymer is 0.1 to 3.0; and
(b) chain extending the polyurethane by reaction with a chain extender selected from one or more bio-based monoamines, polyamines, alcohols, or polyols; and
wherein the chain extension reaction is carried out with 80% to 120% equivalents of the chain extension agent, based on the equivalents of unreacted NCO on the prepolymer;
wherein the % bio-renewable carbon (% BRC) of the polyurethane polymer is equal to or greater than 50%.

2. The polymer of claim 1, wherein the polyol component of the prepolymer comprises a bio-based polyol selected from the group consisting of: those derived from bio-based oils; oils derived from animal fats; sugars; polyols made from bio-based diol 1,3-propanediol (PDO); polyols made from bio-based butanediol (BDO); glycerol monooleate; or derived from diacids.

3. The polymer of claim 2, wherein the polyol is derived from bio-based oils selected from vegetable or seed oils, soy bean oil, rapeseed oil, canola oil, peanut oil, cotton seed oil, sunflower oil, olive oil, grape seed oil, linseed oil, castor oil, fish oils, algal oils, or mustard seed oils.

4. The polymer of claim 1, wherein the % BRC of the polymer is equal to or greater than 60%; preferably equal to or greater than 80%; more preferably equal to 100%.

5. The polymer of claim 1, wherein the chain extender is selected from the group consisting of polyvalent amine compounds; ethylene glycol; propylene glycol; 1,3-propanediol; 1,3-butanediol; 1,4-butanediol; 1,5-pentanediol; 1,6-hexanediol; neopentyl glycol; diethylene glycol; triethylene glycol; tetraethylene glycol; dipropylene glycol; tripropylene glycol; poly(ethylene glycol); 3-methyl-1,5-pentanediol; 2-butyl-2-ethyl-1,3-propanediol; 1,4-cyclohexanediol; 1,4-cyclohexanedimethanol; hydrogenated bisphenol A; glycerin; trimethylolpropane; pentaerythritol; and mixtures thereof.

6. The polymer of claim 5, wherein the polyvalent amine compound is selected from the group consisting of: dimer diamine, trimethylolmelamine and derivatives thereof; dimethylolurea and derivatives thereof; dimethylolethylamine, diethanolmethylamine; dipropanolethylamine; dibutanolmethylamine; ethylenediamine; propylenediamine; diethylenetriamine; hexylenediamine; triethylenetetramine; tetraethylenepentamine; isophoronediamine; xylylenediamine; diphenylmethanediamine; hydrogenated diphenylmethanediamine; hydrazine; polyamide polyamine; polyethylene polyimine; and combinations thereof.

7. The polymer of claim 1, wherein the chain extender is a diamine, and the chain extension reaction is carried out with 80% to 120% equivalents of diamine, based on the equivalents of unreacted NCO on the prepolymer.

8. The polymer of claim 1, wherein the chain extender comprises fatty acid dimer diamine.

9. The polymer of claim 1, comprising an aliphatic isocyanate, wherein the aliphatic isocyanate has 3 to 10 carbon atoms.

10. (canceled)

11. The polymer of claim 1, comprising an aromatic isocyanate, wherein the aromatic isocyanate has 5 to 10 carbon atoms.

12. (canceled)

13. A printing ink or coating composition comprising 10 wt % to 50 wt % of the polymer of claim 1, based on the total weight of the printing ink or coating composition.

14. The printing ink or coating composition of claim 13, which is suitable for lamination printing.

15. The printing ink or coating composition of claim 14, which is a solvent-based lamination ink.

16. The solvent-based lamination ink of claim 15, which has a lamination bond strength of equal to or greater than 1.0 N/15 mm, when used in a laminated article.

17. The solvent-based lamination ink of claim 15, which has a lamination bond strength of equal to or greater than 1.5 N/15 mm.

18. The solvent-based lamination ink of claim 15, which has a lamination bond strength of equal to or greater than 2.0 N/15 mm.

19. A laminated article comprising the printing ink or coating of claim 13.

20. A method of preparing a laminated article, comprising:
(a) providing a first substrate and a second substrate;
(b) applying the solvent-based lamination ink of claim 13 to the first substrate;
(c) drying the solvent-based lamination ink on the first substrate;
(d) applying a layer of an adhesive composition on top of the ink dried on the first substrate; and
(e) placing the second substrate in contact with the adhesive composition to adhere the second substrate to the first substrate;
wherein the solvent-based lamination ink has a lamination bond strength equal to or greater than 1.0 N/15 mm.

21. The method of claim 20, further comprising one or more additional substrates, and wherein the solvent-based lamination ink is printed on one or more of the additional substrates.

22. The method of claim 20, wherein the solvent-based lamination ink has a lamination bond strength equal to or greater than 1.5 N/15 mm.

23. The method of claim 20, wherein the solvent-based lamination ink has a lamination bond strength equal to or greater than 2.0 N/15 mm.
